(19) United States
(12) Patent Application Publication
(10) Pub. No.: US 2007/0030812 A1
(43) Pub. Date: Feb. 8, 2007

(54) Protocol designer

(76) Inventors: Casey R. Mac Donald, Portland, OR (US); Elizabeth A. Muncher, Forest Grove, OR (US)

Correspondence Address: THOMAS F. LENIHAN;TEKTRONIX, INC., 14150 S. W. KARL BRAUN DRIVE, P.O. BOX 500 (50-LAW), BEAVERTON, OR, 97077-0001, US

(21) Appl. No.: 11/197,190

(22) Filed: Aug. 3, 2005

(51) Int. Cl. H04L 12/26

(52) U.S. Cl. 370/241

(57) ABSTRACT

A protocol designer uses an integrated development environment that integrates the editing of protocols and stacks along with the ability to compile the edited protocols. A protocol stack window is opened on a display for creating a new protocol stack or for retrieving and modifying an existing protocol stack. A protocol may be selected from the protocol stack and protocol specific information is provided in a stack information window on the display. Also a selected protocol listing may be displayed in a protocol editor window on the display. The protocol listing may be edited and then compiled as the modified protocol. Any compilation errors are indicated in a compilation results window. Indicated compilation errors point to the line of the listing in the protocol editor window where the error exists, which line may be highlighted.

### BACKGROUND OF THE INVENTION

The present invention relates to protocol design, and more particularly to a protocol designer that provides the ability to a user of editing protocol definitions and stacks and to verify the correct compilation of the edited protocol definitions.

In telecommunications information is transmitted according to certain protocols in the form of packets, each packet having a header with different fields followed by a data field as shown in FIG. 1. Protocol stacks are made up of different protocols in a layered configuration. In other words as shown in FIG. 2 the data packet for the first layer has a header that identifies protocol A and a data field, the data field for protocol A including a header for protocol B and a data field, the data field for protocol B including a header for protocol C and a data field, etc. The information is transmitted as an analog signal representing sequences of 1s and 0s at the physical layer—an unstructured bit stream, which analog data needs to be converted into the digital equivalent and decoded according to the defined protocols. A generic protocol stack is defined by the OSI Reference Model as shown in FIG. 3.

Currently there is no tool available that enables a protocol designer to interactively design, modify or otherwise alter a protocol. Traditional disassemblers coupled with listing displays decode Physical and Data Link layer information. But users want to see information for protocols that are in higher layers of the protocol stack. An electrical or optical signal may be encoded to transmit information according to one or more specified protocols. An oscilloscope may display the signal as a waveform display, and a logic analyzer may interpret the waveform display as a string of digital bits. The string of digital bits may then be decoded to extract the transmitted information using a protocol decoder or analyzer. The decoding requires knowledge of the specified protocol(s). According to the OSI Reference Model of FIG. 3 the protocols are built up in the form of a multi-layer stack. The first layer is a physical layer that encompasses the transmission of unstructured bit streams—the waveform. The second layer is a data link layer that assures error free transmission. The third layer is a network layer for addressing and control. The fourth is a transport layer for transport of the data. The fifth layer is a session layer for establishing, managing and terminating connections. The sixth layer is a presentation layer for meaningful exchange of data—includes encryption, compression reformatting of data. Finally the seventh layer is an application layer that allows Windows^{(r)} applications to access network services. One or more protocols may be used for each layer.

Generally data is acquired from the waveform signal, and the data is processed by a protocol window as shown in FIG. 4. The protocol window accesses a framer to convert the unstructured bit stream (serial or parallel) into packets by determining the start and end indicators of each packet. Then the protocol window accesses stack and protocol definition files to actually decode the packets and extract the transmitted information. The user provides the framing information for the framer as well as the stack and packet definition information. There is no ability for the user to modify the stack or the protocol definitions.

What is desired is a means for users to edit the protocol definitions and stacks and to verify correct interpolation of the edited protocols.

### BRIEF SUMMARY OF THE INVENTION

Accordingly the present invention provides a protocol designer using an integrated development environment that integrates the editing of protocols and stacks along with the ability to compile the edited protocols. A protocol stack window is opened on a display for creating a new protocol stack or for retrieving and modifying an existing protocol stack. A protocol may be selected from the protocol stack and protocol specific information is provided in a stack information window on the display. Also a selected protocol listing may be displayed in a protocol editor window on the display. The protocol listing may be edited and then compiled as the modified protocol. Any compilation errors are indicated in a compilation results window, and such errors indicate the line in the listing where the error exists, which line may be highlighted.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is an illustrative view of a packet of data.

FIG. 2 is an illustrative view of how packets of data are combined to form a multi-layer protocol stack.

FIG. 3 is an illustrative view of an OSI Reference Model for protocol stacks.

FIG. 4 is a block diagram view of a system including a protocol designer according to the present invention.

FIG. 5 is a plan view of a display for accessing the protocol designer according to the present invention.

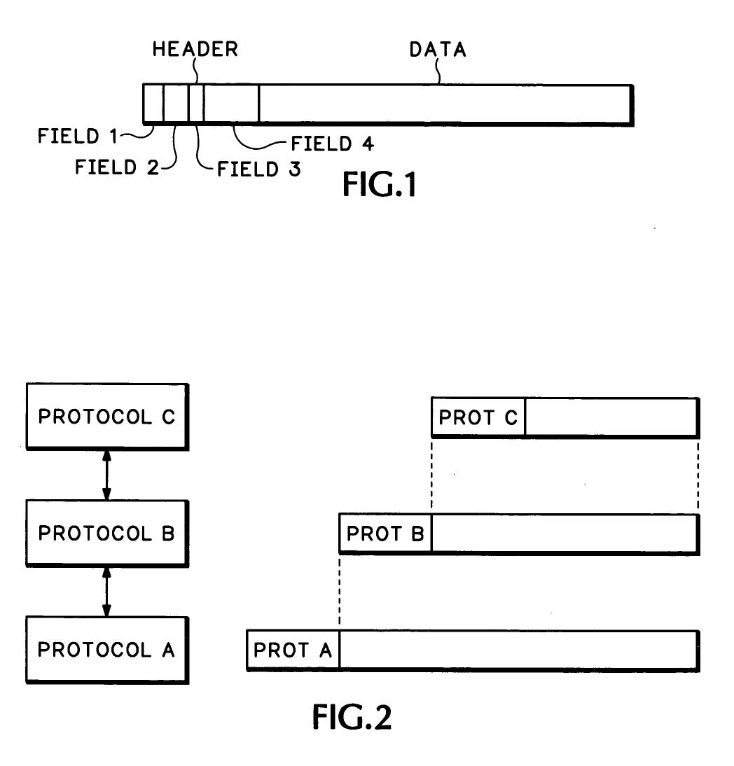

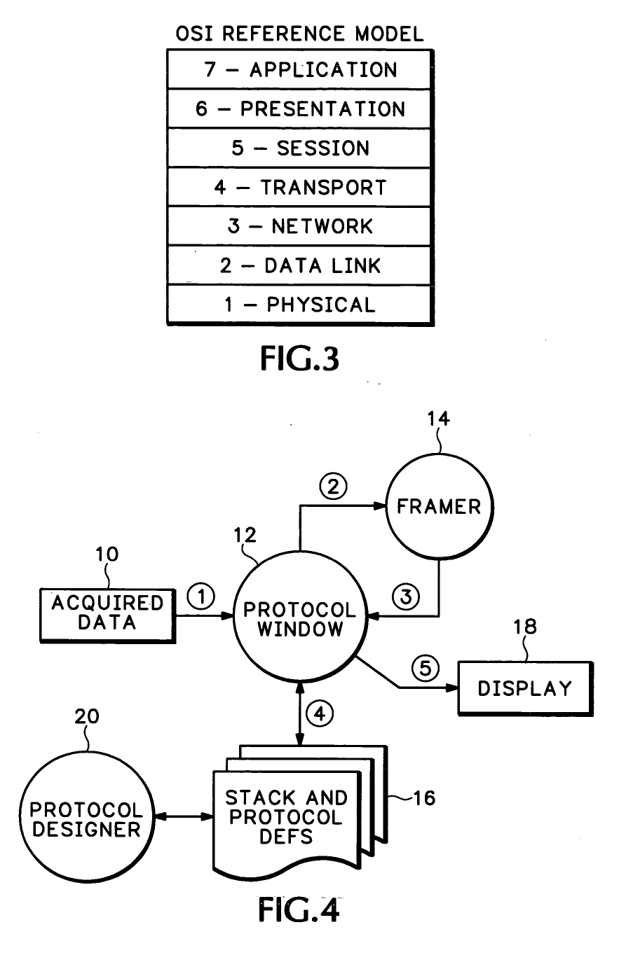

### DETAILED DESCRIPTION OF THE INVENTION

Referring now to FIG. 4 acquired data 10 is input to a protocol window 12 for processing. The protocol window 12 accesses a framer 14 that contains framing architecture information provided by a user, i.e., what kind of bus decoding. The framer 14 provides packetized data from the acquired data by identifying the start and end indicators of the acquired data. The protocol window 12 then accesses stack and protocol definitions files 16 that contain the information on how to decode the packets according to the protocol information provided by the user. The decoded packets may be presented on a display 18 in any desired manner. A protocol designer 20 is added to the system to enable the user to edit the stack and protocol definition files to create a proprietary protocol or modify an existing protocol.

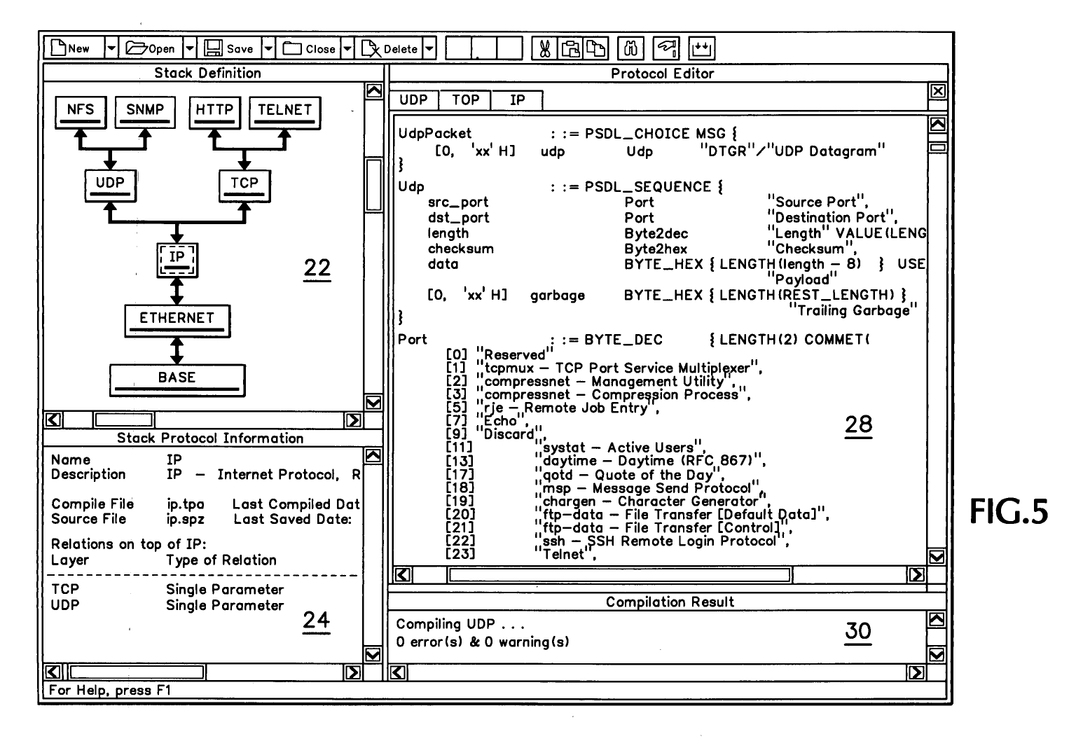

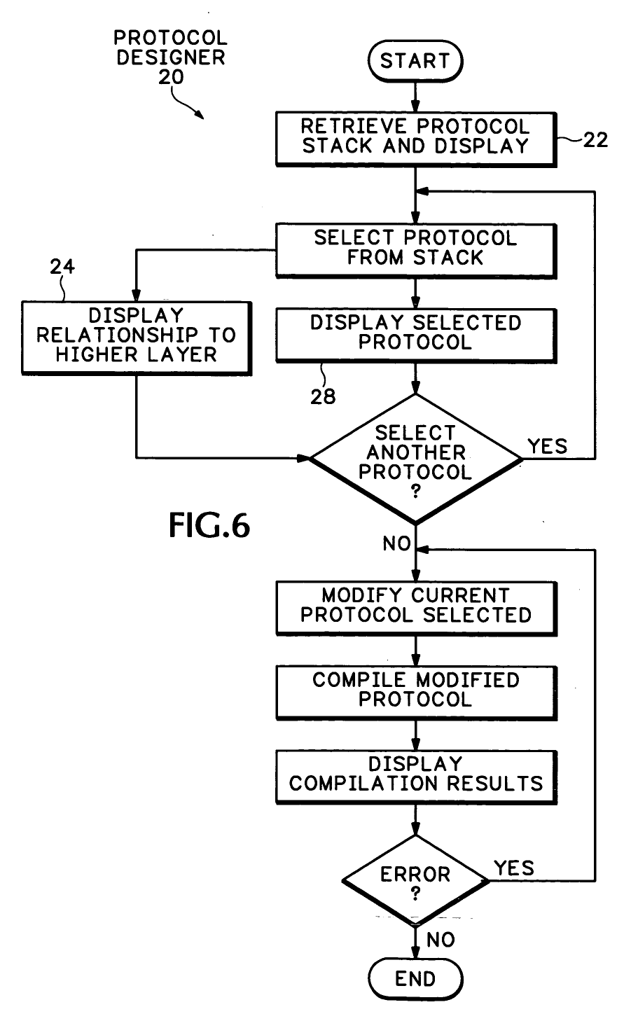

The protocol designer 20 is accessed interactively. The user opens a stack definitions window 22, as shown in FIG. 5, and either creates a protocol stack from scratch or calls up an already existing protocol stack. In the example shown an existing stack is displayed having a base layer (layer 1), an ethernet layer (layer 2), an internet protocol (IP) layer (layer 3), UDP and TCP protocols (layer 4) and several session protocols—RIP, DNS, SNMP and TELNET (layer 5). The stack definitions window 22 is a graphical representation of a current protocol stack definition from the stack file library 16. This graphical user interface (GUI) is a user interactive interface to allow users to add new protocols to the stack, to delete protocols from the stack, to modify relationships between protocols and to graphically modify the size and shape of each protocol box. By selecting a protocol box, such as by placing a cursor on the box and executing a mouse click, more specific information about the protocol is provided in a further stack protocol information window 24. In this instance the IP protocol 26 was last selected and the stack protocol information window 24 shows the relationship of the IP protocol to the protocols above. In this case if a protocol parameter is 17, the UDP protocol is used at the next higher level, while if the protocol parameter is 6, the TCP protocol is used at the next higher level. Also shown are corresponding filename dates for the source and compile files.

The selected protocol box, when selected such as by double mouse clicking on it, opens a protocol editor window 28. It is this window that allows a user to edit the selected protocol. Many protocols may be selected in the protocol editor window 28 after being opened in the stack definition window 22, as indicated by appropriate tabs, and the protocol selected currently is displayed in full in the window—UDP in this example. The user may edit the protocols using a protocol language, such as the Tektronix protocol language of Packet Structured Definition Language (PSDL) which is based on ASN1, an industry standard. After the protocol has been edited, it may then be compiled by an appropriate compiler. The compilation results are shown in a compilation result window 30—in this example there were no errors or warnings. In the event there is an error shown in the compilation result window 30, a corresponding line number in which the error occurred is shown. Double clicking on this error results in the cursor highlighting the designated line in the protocol editor window 28. The user then may correct the error and recompile.

A simple protocol may be defined by the following PSDLconstruct:

| | | |
|---|---|---|
| DESCRIPTION | ::= | “Simple Protocol” |
| PACKET | ::= | SimplePacket |
| SimplePacket | ::= | PSDL_SEQUENCE { |

| | | |
|---|---|---|
| address | Address | “Pkt_Address”, |

| | | |
|---|---|---|
| length | Length | “Pkt_Length”, |

| | | |
|---|---|---|
| info | Information | “Pkt_Information”, |

| | | |
|---|---|---|
| payload | PayloadData | “Payload Data” |

}

| | | |
|---|---|---|
| Address | ::= | BYTE_HEX {LENGTH(1)} |
| Length | ::= | BYTE_HEX {LENGTH(2)} |
| Information | ::= | BYTE_HEX {LENGTH(length)} |

| | | |
|---|---|---|
| PayloadData | ::= | BYTE_HEX |

{LENGTH(REST_LENGTH)}
USER_DATA

In this simple protocol example the address field is one byte, the length definition is two bytes and the information field is of variable length according to the value of “Length”.

Thus the present invention provides a protocol designer in an integrated development environment that presents a user with a multi-view editing palette for simultaneous editing of both stack and protocols at any layer of the stack.

What is claimed is:

1. A protocol designer method comprising the steps of:
retrieving a protocol stack from a stack file and displaying the protocol stack in a protocol stack window on a display;
selecting a protocol from the protocol stack and displaying protocol specific information in a stack information window on the display;
selecting the protocol and displaying a protocol listing in a protocol editor window on the display; and
editing the protocol listing and compiling the edited protocol listing to modify the selected protocol.

2. The protocol designer method as recited in claim 1 further comprising the steps of:
providing compilation results from the compiling step in a compilation results window on the display; and
highlighting a line of the protocol listing in the protocol editor window corresponding to an error detected during the compiling step.
